(19) United States
(12) Patent Application Publication
(10) Pub. No.: US 2025/0206869 A1
(43) Pub. Date: Jun. 26, 2025

(54) CROSSLINKABLE AQUEOUS COATING COMPOSITION

(71) Applicant: BONA AB, Malmö (SE)

(72) Inventors: Cecilia HANSSON, Lund (SE); Nicola REHNBERG, Landskrona (SE)

(21) Appl. No.: 18/844,855

(22) PCT Filed: Mar. 8, 2023
(86) PCT No.: PCT/SE2023/050217

§ 371 Date: Sep. 6, 2024

(30) Foreign Application Priority Data
Mar. 10, 2022 (SE) 2250313-0

(51) Int. Cl. C08G 18/08; C08F 2/16; C08F 283/00; C08G 18/12; C08G 18/42; C08G 18/48; C08K 5/25; C09D 7/20; C09D 7/43; C09D 7/63; C09D 175/14

(52) U.S. Cl. CPC C08G 18/0866; C08F 2/16; C08F 283/008; C08G 18/0814; C08G 18/0823; C08G 18/12; C08G 18/4202; C08G 18/4854; C08K 5/25; C09D 7/20; C09D 7/43; C09D 7/63; C09D 175/14; C08G 2150/00

(57) ABSTRACT

A crosslinkable aqueous polyurethane dispersion comprising at least one dihydrazide is described.

### TECHNICAL FIELD OF THE INVENTION

The present invention relates to crosslinkable aqueous polyurethane dispersions, which dispersions may be used as floor coatings.

### BACKGROUND OF THE INVENTION

Aqueous coating compositions comprising aqueous polyurethane dispersions are widely used to create a protective film coating on various substrates, such as wood, plastics, or metals. Crosslinking is an efficient method to increase the durability of the film coating in terms of increased hardness, chemical- and mark resistance. For a floor coating a very noticeable factor of durability is the black mark resistance (BMR). Black mark resistance refers to a floor finish's ability to resist marking when objects, such as shoes, move across it. Self-crosslinking of a coating could be introduced by incorporating desired chain-pendants or in-chain groups in the polymer molecules. For example, it is known that carbonyl groups, incorporated in the polymer, when employed in an aqueous coating composition, can undergo self-crosslinking during drying and film formation, by virtue of reaction with a compound bearing at least two carbonyl-reactive groups, i.e., polyhydrazide.

The preparation of carbonyl functionalised polyurethanes crosslinked by polyhydrazides is described in prior art.

U.S. Pat. No. 5,147,926A discloses crosslinkable aqueous dispersions of polyurethanes from carbonyl containing mono- and polyalcohols. The carbonyl containing polyalcohols are well described and include polyesterpolyols from ketocarboxylic acids, diacids and polyols. Polyurethanes are known to easily build up viscosity. According to U.S. Pat. No. 5,147,926A, high viscosity is avoided by terminating the addition polymerization using monoalcohols. This results in polymers of reduced average molecular weight and deteriorated durability of the film coating.

U.S. Pat. No. 4,983,662A discloses an aqueous crosslinkable coating composition containing a polyurethane/polyurea polymer having pendant carbonyl functional groups and an acrylic copolymer. The pendant carbonyl functional groups are introduced by a carbonyl containing isocyanate reactive compound, such as dihydroxy acetone or adducts from the Michael addition of diacetoneacrylamide with a diamine or an alkanolamine. The Michael addition has low selectivity, and the product contains tertiary amines, which introduces cations to the polymer backbone, and has a negative impact on the stability of the aqueous dispersion. Dihydroxyacetone is a hygroscopic compound and is in its regular form present as a dimer.

U.S. Pat. No. 6,544,592 describes the preparation of a ketone functional polyurethane/polyurea dispersion, in which the ketone functional group is incorporated in the polyurethane backbone by reacting a polyisocyanate with a polyesterdiol containing ketone functions. The viscosity of the polyurethane prepolymer is regulated by N-methyl-pyrrolidone, a highly unwanted solvent since it may damage fertility or the unborn child.

US20150079406 describes a process for preparing a cross-linkable dispersion of polyurethane and a vinyl polymer. The polyurethane has ketone functional groups, which have been incorporated by reacting a polyisocyanate with a polyesterdiol containing ketone functions. The polyurethane is made dispersible in water by neutralising the isocyanate carboxylate prepolymer with an alkali base. Alkali bases remain in the film coating after drying and make the film more sensitive towards water and other chemicals.

US20080027168 and US20060264568 discloses aqueous non-covalent mixtures of ketone functional polyesters and polyurethanes.

U.S. Pat. No. 5,571,861 discloses self-crosslinking aqueous polyurethane-vinyl hybrid dispersions. A carbonyl-containing polyurethane-vinyl hybrid polymer is prepared by free-radical initiated polymerization of polyurethane macromonomers, which contain terminal or latent vinyl groups, with carbonyl containing vinyl monomers.

US20100197856 discloses a self-crosslinking binder for coating compositions comprising an aqueously dispersed ketone-terminated polyurethane resin.

US20020040093 discloses an aqueous dispersion of a terminal aldehyde-functional polyurethane. Aldehydes are prone to undergo oxidation.

WO9711103 discloses aqueous dispersions containing polyurethanes, containing structural units derived from acetoacylated alkanolamines.

### SUMMARY OF THE INVENTION

It is an object of certain aspects of the present invention to provide an improvement over the above described compositions and known prior art; particularly to achieve a coating composition providing an improved stain resistance and black mark resistance.

These objects and advantages are achieved by a crosslinkable aqueous polyurethane dispersion comprising at least one dihydrazide.
The dihydrazide may be adipic acid dihydrazide (ADH).
The dispersion may further comprise a ketone functionalized urethane/urea polymer.
The dispersion may further comprise a vinyl polymer.
The ketone functionalized urethane/urea polymer may be obtained using:
a) polyisocyanate,
b) ketone polyester polyol,
c) carboxylic acid polyol,
d) ammonia and/or tertiary amine.
e) optionally one or more polymeric compounds,
f) optionally polyol, MW <400 Dalton,
wherein the product of a)-f) is chain extended by a polyamine.
The polyisocyanate in a) may be an aliphatic, cycloaliphatic, or aromatic polyisocyanate, or a combination thereof.
The polyisocyanate may be selected from the group consisting of isophorone diisocyanate, 1,6-hexamethylene diisocyanate, 4,4′-dicyclohexylmethane diisocyanate, cyclohexane-1,4-diisocyanate, 2,4-toluene diisocyanate·2,6-toluene diisocyanate, tetramethylxylene diisocyanate, p-xylylene diisocyanate, 1,4-phenylene diisocyanate, 4,4′-diphenylmethane diisocyanate, 2,4′-diphenylmethane diisocyanate, polymethylene polyphenyl polyisocyanates, 1,5-naphthylene diisocyanate, or urethane, allophanate, urea, biuret, carbodiimide, uretonimine or isocyanurate derivatives thereof, or combinations thereof.
The ketone polyester polyol in b) may be a product of keto carboxylic acids, alkyl keto carboxylates, polyols and diacids.
The polyols may be selected from trimethylolpropane or glycerol, said keto carboxylic acids are levulinic acid, said alkyl keto carboxylates are selected from methyl levulinate or ethyl levulinate, and said diacids may be selected from the group consisting of succinic acid, glutaric acid, adipic acid, sebacic acid, hexahydrophtalic acid, isophtalic acid, phthalic anhydride or dimethyl terephthalate.
A proportion of the ketone group in the ketone polyester polyol in b) may be in the range of 0.8 to 4 meq/g, preferably 1 to 3.5 meq/g, more preferably 2 to 3.5 meq/g.
The polymeric compounds in e) may be polymeric polyols, MW 400-3000 Dalton.
The polymeric polyols may be selected from the group consisting of polyether polyols, polycarbonate polyols, polyester polyols, polyesteramide polyols, dimer fatty polyols, polyolefin polyols or polysiloxane polyols.
The carboxylic acid polyol in c) may be 2,2-bis(hydroxymethyl) propionic acid.
The tertiary amine in d) may be selected from the group consisting of triethylamine, dimethylcyclohexylamine, N-methylmorpholine, N-ethylmorpholine, N,N-diisopropylethylamine, tris-(hydroxyethyl)amine, N,N-dimethylaminoethanol, or N,N-diethylaminoethanol.
The dispersion may further comprise coalescing aids and/or additives, Said coalescing aids and/or additives may be selected from the group consisting of waxes, matting agents, pigments, flow- and levelling agents and defoamers.
The crosslinkable aqueous polyurethane dispersion may be a floor coating composition.
According to one aspect there is provided a process for preparing a crosslinkable aqueous polyurethane dispersion according to the above, comprising the steps of:
a) reacting diisocyanate, ketone polyester polyol, carboxylic acid polyol (DMPA), optionally polymeric polyol (MW 400-3000 Dalton), and optionally polyol (MW<400 Dalton),
b) adding to the reaction mixture from step a) a neutralizing agent,
c) dispersing the product from step b) in water; and
d) chain extending the product from step c) using a polyamine.
The neutralizing agent in step b) may be selected from the group consisting of ammonia, triethylamine, dimethylcyclohexylamine, N-methylmorpholine, N-ethylmorpholine, N,N-diisopropylethylamine, tris-(hydroxyethyl) amine, N,N-dimethylaminoethanol, N,N-diethylaminoethanol.

### DETAILED DESCRIPTION

Specific embodiments of the invention will now be described. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments is not intended to be limiting of the invention. The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

It should be noted that the word “comprising” does not necessarily exclude the presence of other elements or steps than those listed and the words “a” or “an” preceding an element do not exclude the presence of a plurality of such elements.

The different aspects, alternatives and embodiments of the invention disclosed herein can be combined with one or more of the other aspects, alternatives and embodiments described herein. Two or more aspects can be combined.

It has been found that floor coating compositions from dispersions of polyurethane/polyurea with chain pendant ketone groups and dihydrazides have superior chemical-, scratch- and black mark resistance. These are properties of high value for a floor coating.

A favoured route for obtaining an aqueous polyurethane dispersion is to react polyisocyanates with active hydrogen containing compounds, such as polyols, to form an isocyanate terminated prepolymer mixture. The active hydrogen containing compounds include compounds which enhance the dispersibility and compounds with carbonyl functionality. Water dispersibility enhancing compounds of particular interest are those which can incorporate carboxyl groups into the prepolymer. The carbonyl functionality may be introduced into the polymer backbone during the prepolymer synthesis by means of reacting the polyisocyanate with ketone polyesterpolyols. Suitable ketone polyesterpolyols are those obtainable by partial esterification of ketocarboxylic acids with polyols or partial transesterification of ketocarboxylates with polyols as described in e.g., U.S. Pat. No. 5,147,926 column 2-3. The ketone polyesterpolyol is preferably made from diacids, polyols and keto carboxylic acids, more preferably diacids, trimethylolpropane and levulinic acid.

The isocyanate terminated prepolymer mixture is neutralized by reaction with at least one neutralizing agent, dispersed in aqueous medium, and chain extended with polyamines, to eventually form polyurethane/poly-urea polymers.

The polyhydrazides are typically added after dispersion and/or chain extension, though they could be added earlier with chain extender or co-extender.

In one embodiment of the present invention, isocyanates are reacted with active hydrogen containing compounds in the presence of acrylate and/or methacrylate monomers. The acrylate and/or methacrylate monomers could optionally include ketone functionalized acrylate and/or methacrylate monomers. After dispersion of the prepolymer mixture the acrylate/methacrylate monomers are polymerised by any suitable free-radical initiated polymerisation technique.

In one embodiment of the invention, isocyanates are reacted with active hydrogen containing compounds in the presence of a solvent or a solvent mixture. The solvent could either remain in the aqueous polyurethane/polyurea dispersion or be removed by distillation. The dispersion is formulated into a coating by the addition of suitable coalescing aids and additives, such as waxes, matting agents, pigments, flow- and levelling agents and defoamers.

The coating may e.g., be applied on a wood or plastic flooring.

The polyisocyanate used in the urethane prepolymer synthesis may be an aliphatic, cycloaliphatic, or aromatic polyisocyanate. A single polyisocyanate or, alternatively, mixtures of polyisocyanates, may be used. Suitable polyisocyanates include isophorone diisocyanate, 1,6-hexamethylene diisocyanate, 4,4′-dicyclohexylmethane diisocyanate, cyclohexane-1,4-diisocyanate, 2,4-toluene diisocyanate, 2,6-toluene diisocyanate, tetramethylxylene diisocyanate, p-xylylene diisocyanate, 1,4-phenylene diisocyanate, 4,4′-diphenylmethane diisocyanate, 2,4′-diphenylmethane diisocyanate, polymethylene polyphenyl polyisocyanates, 1,5-naphthylene diisocyanate. Urethane, allophanate, urea, biuret, carbodiimide, uretonimine or isocyanurate derivatives of the above mentioned polyisocyanates may also be used.

Active hydrogen containing compounds used in the urethane prepolymer synthesis may be polymeric compounds having weight average molecular weights ranging from 400 to 3000, and are preferably polymeric polyols. The polymeric polyols include diols and triols and mixtures thereof. The polymeric polyols may be polyether polyols, polycarbonate polyols, polyester polyols, polyesteramide polyols, dimer fatty polyols, polyolefin polyols or polysiloxane polyols. Preferred polyol molecular weights range from 500 to 2500.

Polyester polyols which may be used include reaction products of polyols with mono and/or polycarboxylic acids, ester derivatives thereof or acid anhydrides. Polyols include examples such as neopentyl glycol, 2-butyl-2-ethyl-1,3-propanediol, 1,4-butanediol, 1,6-hexandiol, ethylene glycol, propylene glycol, diethylene glycol, cyclohexane dimethanol, dimer fatty polyols, furan dimethanol, glycerol, trimethylolpropane or pentaerythritol, or mixtures thereof.

Polycarboxylic acids, polycarboxylic ester derivatives and acid anhydrides include examples such as succinic, glutaric, adipic and sebacic acid, dimer fatty acids, hexahydrophtalic acid, isophtalic acid, phthalic anhydride or dimethyl terephthalate. The monocarboxylic acids are preferably C8 to C22 acids, including examples such as 2-ethyl-hexanoic acid, decanoic acid, octanoic acid, isostearic acid, stearic acid and palmitic acid.

Polyester polyols obtained by the polymerisation of lactones, for example caprolactone, together with a polyol, may also be used.

Polyether polyols include examples such as products from the polymerisation of cyclic oxides, for example ethylene oxide, propylene oxide or tetrahydrofuran, or by the addition of such oxides to polyfunctional initiators.

Polycarbonate polyols which may be used include products obtained by reacting diols, such as diethylene glycol, 1,3-propanediol, 1,4-butanediol, 1,6-hexanediol or tetramethylene glycol, with dialkyl or diaryl carbonates or cyclic carbonates, or alternatively with phosgene.

Suitable polyolefin polyols include hydroxy-terminated butadiene homo- and copolymers.

Active hydrogen containing compounds used in the urethane prepolymer synthesis may be a polyol having a molecular weight below 400 Dalton, including examples such as neopentyl glycol, 2-butyl-2-ethyl-1,3-propanediol, 1,4-butanediol, 1,6-hexandiol, ethylene glycol, propylene glycol, diethylene glycol, cyclohexane dimethanol, furan dimethanol, glycerol, trimethylolpropane or pentaerythritol, or the reaction products of such polyols with propylene oxide and/or ethylene oxide.

To enhance the polyurethane prepolymers dispersibility in water, active hydrogen containing compounds bearing non-ionic and/or ionic dispersing groups, or groups which may be converted to such dispersing groups, are included as reactants in the prepolymer synthesis.

Active hydrogen containing compounds bearing ionic groups could also be added after the dispersing step. Typically, groups which may be converted to ionic dispersing groups are carboxylic acid groups, incorporated by means of an isocyanate-reactive compound having at least one acid group and at least two hydroxyl groups. Examples of such compounds include 2,2-bis (hydroxymethyl) propionic acid and 2,2-bis(hydroxymethyl)butanonic acid. The carboxylic acid containing diol may also be incorporated into a polyesterpolyol, by reaction with a dicarboxylic acid, before being incorporated into the urethane prepolymer. Any acid groups present in the prepolymer could be converted to anionic salt groups by neutralising said acidic groups before, after (if in combination with non-ionic stabilisation) or simultaneously with formation of an aqueous dispersion of the prepolymer.

Typically, ionic dispersing groups which are incorporated simultaneously or after the dispersing step are sulphonate salt groups, incorporated by means of an isocyanate-reactive compound having at least one sulphonate group and at least two amine groups. An examples of such compounds is sodium 2-[(2-aminoethyl)amino]ethanesulphonate.

Non-ionic dispersing groups are typically pendant monoalkylated polyoxyalkylene groups, particularly methylated polyoxyethylene groups, typically with 8-25 units of ethyleneoxide. Typically, the active hydrogen containing compounds bearing non-ionic dispersing groups are difunctional polyethylene glycol monomethyl ether, such as Ymer N90, Ymer N120 or Ymer N180 (available from Perstorp) or Tegomer D3403 (available from Evonik).

Active hydrogen containing compounds used in the urethane prepolymer synthesis may be a ketone polyester polyol, such as described in U.S. Pat. No. 5,147,926, column 2, line 57, to column 3, line 24, having weight average molecular weights ranging from 400 to 3000, preferably ranging from 500 to 1500, more preferably 500 to 1000. The proportion of the ketone group in the ketone polyester polyol is typically in the range from 0.8 to 4 meq/g, preferably 1 to 3.5 meq/g, more preferably 2 to 3.5 meq/g. The ketone polyester polyols which may be used include reaction products of polyols with polycarboxylic acids, ester derivatives thereof or acid anhydrides, and keto carboxylic acids or esters thereof. Polyols include examples such as glycerol, trimethylolpropane, pentaerythritol, dineopentylglycol, ditrimethylolpropane, dipentaerythritol, neopentyl glycol, 2-butyl-2-ethyl-1,3-propanediol, 1,4-butanediol, 1,6-hexandiol, ethylene glycol, propylene glycol, diethylene glycol, cyclohexane dimethanol, dimer fatty polyols, furan dimethanol, alkoxylated polyols such as ethoxylated or propoxylated neopentylglycols, trimethylolpropane, ditrimethylolpropane, dipentaerythritol, or mixtures thereof. Polycarboxylic acids, polycarboxylic ester derivatives and acid anhydrides include examples such as succinic acid, glutaric acid, adipic acid, sebacic acid, dimer fatty acids, hexahydrophtalic acid, isophtalic acid, phthalic anhydride or dimethyl terephthalate. The keto carboxylic acids or esters thereof include examples such as levulinic acid, alkyl levulinates, such as methyl levulinate or ethyl levulinate, pyruvic acid, alkyl pyruvates, alkyl acetoacetates, such as methyl acetoacetate, ethyl acetoacetate and t-butyl acetoacetate.

Neutralizing agents may be added to the prepolymer mixture, or already be present in the water during the dispersing stage, to convert ionizable groups into ionic dispersing groups. Examples of neutralizing agents include compounds such ammonia, triethylamine, dimethylcyclohexylamine, N-methylmorpholine, N-ethylmorpholine, N,N-diisopropylethylamine, tris-(hydroxyethyl) amine, N,N-dimethylaminoethanol, N,N-diethylaminoethanol, or alkali metal salts, such as lithium, potassium or sodium hydroxide or carbonate.

Optionally the active hydrogen containing compounds is a vinyl monomer which contains at least one group which is reactive toward isocyanate, such as hydroxyethyl(meth)acrylate, hydroxybutyl(meth)acrylate or 2-tert-butylaminoethyl(meth)acrylate.

Optionally, the polyurethane prepolymer synthesis could be performed in the presence of a catalyst or a mixture of catalysts, such as a tin, bismuth or zinc compound, an amine, a phosphoric acid or a phosphate.

Optionally, the polyurethane prepolymer synthesis could be performed in the presence of polymerizable acrylate and/or methacrylate monomers, such as butyl(meth)acrylate, methyl(meth)acrylate, t-butyl(meth)acrylate, ethyl(meth)acrylate, lauryl (meth)acrylate, isobornyl (meth)acrylate, diacetone acrylamide. 2-ethylhexyl (meth)acrylate, 2-octyl (meth)acrylate.

Optionally, the polyurethane prepolymer synthesis could be performed in the presence of a solvent or a solvent mixture, such as acetone, 2-butanone, N-methylpyrrolidone, N-ethylpyrrolidone, N-vinylpyrrolidone, N-vinylcaprolactame, diacetone alcohol, caprolactone, ethylene carbonate, propylene carbonate, ethyl acetate, ethyleneglycol diacetate, propylenglycol diacetate, dimethyl succinate, dimethyl glutarate, diisopropyl ether, ethyleneglycol dimethyl ether, diethyleneglycol dimethyl ether, triethylene-glycol dimethyl ether, propylene glycol dimethyl ether, dipropyleneglycol dimethyl ether, tripropyleneglycol dimethyl ether, diacetoneacrylamide, N-tert-butylacrylamide, N-acetylmorpholine or dimethyl isosorbide.

Chain extenders may be added to the aqueous dispersion of the polyurethane prepolymer, or may be present in the water during the dispersing stage. Chain extenders include examples such as ethylenediamine, propylenediamine, butylenediamine, pentylenediamine, hexylenediamine, diethylenetriamine, isophorondiamine, hydrazine, adipic acid dihydrazide, amino polyalkylene oxide, or a mixture thereof. Water could also be used as a chain extender.

The hydrazide functional moieties are added in the amount of 0.5 to 1.5 equivalents to the amount of ketone in the polyurethane aqueous dispersion. The polyhydrazide compounds include compounds such as carbo dihydrazide, succinic dihydrazide, adipic acid dihydrazide, sebacic acid dihydrazide, valine dihydrazide, isophthalic dihydrazide, or mixtures thereof.

### EXAMPLES

H12MDI=4,4′-diisocyanato dicyclohexylmethane
IPDI=Isophorone diisocyanate
PE-1=Ketone polyester polyol, such as described in U.S. Pat. No. 5,147,926, column 2, line 57, to column 3, line 24, available from SBHPP
Durez-ter S1175-110=Ketone polyester polyol, such as described in
U.S. Pat. No. 5,147,926, column 2, line 57, to column 3, line 24, available from SBHPP
DMPA=2,2-bis(hydroxymethyl) propionic acid
DMM=dipropylenglycol dimethyl ether
BMA=butyl methacrylate
MMA=methyl methacrylate
TEA=triethylamine
EDA=1,2-ethylenediamine
pTHF1000 and pTHF650 available from BASF
Bester 101 available from Dow

### Example 1

H12MDI (243 parts), DMPA (28 parts) and DMM (20 parts) were mixed in a reaction flask under dry air and heated to 40° C. A mixture of PE-1 (OH=180 mg KOH/g, 3.2 meq ketone/g) (66 parts) and pTHF1000 (OH=110 mg KOH/g, 221 parts) was added. The mixture was heated to 85° C. and BMA (72 parts), MMA (30 parts) and p-methoxyphenol (0.06 parts) were added in portions while the temperature was kept at 85° C. When the isocyanate content reached 4.8%, TEA (22 parts) was added and the mixture was added to water (1168 parts) under vigorous stirring. EDA (20 parts) in water (61 parts) was added to the dispersion, which was then transferred to a new reaction flask purged with nitrogen. Radical polymerization was initiated by addition of Fe-EDTA solution (5.4 mM, 20 parts), ascorbic acid (1% solution in water, 12 parts) and t-butyl hydroperoxide (0.2 parts) in water (2 parts). The reaction mixture was kept at 40° C. for 1 h, then ascorbic acid (1% solution in water, 12 parts) and t-butyl hydroperoxide (0.4 parts) in water (4 parts) were added. The aqueous dispersion had a pH of 7.3 and a zₐᵥₑ of 50 nm.

### Comparative Example 1

H12MDI (242 parts), DMPA (28 parts) and DMM (20 parts) were mixed in a reaction flask under dry air and heated to 40° C. A mixture of pTHF1000 (OH=110 mg KOH/g. 219 parts) and pTHF650 (OH=172 mg KOH/g, 68 parts) was added. The mixture was heated to 85° C. and BMA (72 parts), MMA (30 parts) and p-methoxyphenol (0.06 parts) were added in portions while the temperature was kept at 85° C. When the isocyanate content reached 4.8%, TEA (21 parts) was added and the mixture was added to water (1168 parts) under vigorous stirring. EDA (20 parts) in water (61 parts) was added. The dispersion was then transferred to a reaction flask purged with nitrogen. Radical polymerization was initiated by addition of Fe-EDTA solution (5.4 mM, 20 parts), ascorbic acid (1% solution in water, 12 parts) and t-butyl hydroperoxide (0.2 parts) in water (2 parts). The reaction mixture was kept at 40° C. for 1 h, then ascorbic acid (1% solution in water, 12 parts) and t-butyl hydroperoxide (0.4 parts) in water (4 parts) were added. The aqueous dispersion had a pH of 7.5 and a zₐᵥₑ of 56 nm.

### Example 2

IPDI (235 parts), DMPA (27 parts) and DMM (20 parts) were mixed in a reaction flask under dry air and heated to 40° C. A mixture of Durez-Ter S1175-110 (OH=110 mg KOH/g, 1 meq ketone/g) (280 parts) and neopentylglycol (10 parts) was added. The mixture was heated to 85° C. and MMA (102 parts) and p-methoxyphenol (0.06 parts) were added in portions while the temperature was kept at 85° C. When the isocyanate content reached 6.0%, TEA (20 parts) was added and the mixture was added to water (1154 parts) under vigorous stirring. EDA (25 parts) in water (76 parts) was added. The dispersion was then transferred to a reaction flask purged with nitrogen. Radical polymerization was initiated by addition of Fe-EDTA solution (5.4 mM, 20 parts), ascorbic acid (1% solution in water, 12 parts) and t-butyl hydroperoxide (0.2 parts) in water (2 parts). The reaction mixture was kept at 40° C. for 1 h, then ascorbic acid (1% solution in water, 12 parts) and t-butyl hydroperoxide (0.4 parts) in water (4 parts) were added. The aqueous dispersion had a pH of 7.7 and a zₐᵥₑ of 54 nm.

### Comparative Example 2

IPDI (235 parts), DMPA (27 parts) and DMM (20 parts) were mixed in a reaction flask under dry air and heated to 40° C. A mixture of Bester 101 (OH=110 mg KOH/g, 280 parts) and neopentylglycol (10 parts) was added. The mixture was heated to 85° C. and MMA (102 parts) and p-methoxyphenol (0.06 parts) were added in portions while the temperature was kept at 85° C. When the isocyanate content reached 6.0%, TEA (20 parts) was added and the mixture was added to water (1154 parts) under vigorous stirring. EDA (25 parts) in water (76 parts) was added to the dispersion. The resulting dispersion was transferred to a reaction flask purged with nitrogen. Radical polymerization was initiated by addition of Fe-EDTA solution (5.4 mM, 20 parts), ascorbic acid (1% solution in water, 12 parts) and t-butyl hydroperoxide (0.2 parts) in water (2 parts). The reaction mixture was kept at 40° C. for 1 h, then ascorbic acid (1% solution in water, 12 parts) and t-butyl hydroperoxide (0.4 parts) in water (4 parts) were added. The aqueous dispersion had a pH of 7.6 and a zₐᵥₑ of 52 nm.

Table 1 below shows properties of the compositions according to example 1 and 2 and comparative example 1 and 2.

TABLE 1

| | Coating A | Coating B | Coating C | Coating D |
|---|---|---|---|---|
| Dispersion | Ex1 | Comp Ex1 | Ex2 | Comp Ex2 |
| | 96.6 parts | 96.6 parts | 96.6 parts | 96.6 parts |
| DPM | 6.27 parts | 6.27 parts | 6.27 parts | 6.27 parts |
| BYK 3456 | 0.44 parts | 0.44 parts | 0.44 parts | 0.44 parts |
| Tafigel PUR | 1.05 parts | 1.05 parts | 1.05 parts | 1.05 parts |
| 80B | | | | |
| Byk 024 | 0.15 parts | 0.15 parts | 0.15 parts | 0.15 parts |
| Water | 12.46 parts | 14.84 parts | 12.46 parts | 14.84 parts |
| ADH (15% | 4.75 parts | — | 4.75 parts | — |
| solution in | | | | |
| water) | | | | |

### Tests

### Black Mark Resistance

Table 2 shows the black marks resistance (BMR), i.e. the floor finish's ability to resist marking when objects, such as shoes, move across it, for the compositions according to example 1 and example 2, and also comparative example 1 and comparative example 2. The composition was applied on a Leneta chart and dried at room temperature. The black mark resistance was tested 1 day and 14 days after applying of the compositions. The dried surface was struck by a piece of rubber, with enough force to leave a strong black mark on the surface. The mark was removed with finger or paper. The remaining mark was evaluated by ranking on scale 0 till 5, where:
0: no mark
1: small mark(s) or slight change in gloss
2: easily visible change in gloss/scratches
3: light black marks
4: black marks
5: extremely black marks

TABLE 2

| | BMR | BMR |
|---|---|---|
| | (1 day) | (14 days) |
| Coating A | 0 | 0 |
| Coating B | 4 | 4 |
| Coating C | 0 | 0 |
| Coating D | 4 | 4 |

### Stain Resistance

Stains were applied for 1 hour, cleaned with water, and the film coating was inspected after 24 h to observe the change.

TABLE 3

| | | | Acetic | Bona | | |
|---|---|---|---|---|---|---|
| | | Ethanol | acid | Fernox | | |
| | Water | (50%) | (20%) | (10%) | Wine | Espresso |
| | 1 d/14 d | 1 d/14 d | 1 d/14 d | 1 d/14 d | 1 d/14 d | 1 d/14 d |
| Coating A | 5/5 | 4/5 | 2/2 | 5/5 | 3/4 | 2/2 |
| Coating B | 5/5 | 1/4 | 1/1 | 5/5 | 3/3 | 2/2 |
| Coating C | 5/5 | 3/3 | 2/2 | 5/5 | 4/5 | 2/3 |
| Coating D | 5/5 | 1/1 | 1/1 | 4/3 | 5/5 | 2/3 |

Bona Fernox: Basic cleaner solution, available from Bona
1: strong change
2: significant change
3: moderate change
4: minor change
5: no change

### Results and Discussion

The results of the tests clearly show that compositions of the present invention gave a strong black mark resistance, where no marks were seen on the surface which had been coated using the coating composition according to the present invention. Distinct strong marks were, however, noticed when using the coating compositions of the comparative examples.

Further, the stain resistance was strongly improved, as can be seen in Table 3, reducing how much the different chemicals that were applied on the panels did affect them.

1.-14. (canceled)

15. A crosslinkable aqueous polyurethane dispersion comprising at least one dihydrazide and a ketone functionalized urethane/urea polymer,
wherein said ketone functionalized urethane/urea polymer is obtained using:
a) polyisocyanate,
b) ketone polyester polyol, wherein said ketone polyester polyol is a product of levulinic acid, methyl levulinate or ethyl levulinate, trimethylolpropane or glycerol, and diacids
c) carboxylic acid polyol,
d) ammonia and/or tertiary amine,
e) optionally one or more polymeric compounds,
f) optionally polyol, MW <400 Dalton and wherein the product of a)-f) is chain extended by a polyamine.

16. A crosslinkable aqueous polyurethane dispersion according to claim 15, wherein said dihydrazide is adipic acid dihydrazide (ADH).

17. A crosslinkable aqueous polyurethane dispersion according to claim 15, further comprising a vinyl polymer.

18. A crosslinkable aqueous polyurethane dispersion according to claim 15, wherein said polyisocyanate in a) is an aliphatic, cycloaliphatic, or aromatic polyisocyanate, or a combination thereof.

19. A crosslinkable aqueous polyurethane dispersion according to claim 15, wherein said polyisocyanate is selected from the group consisting of isophorone diisocyanate, 1,6-hexamethylene diisocyanate, 4,4′-dicyclohexylmethane diisocyanate, cyclohexane-1,4-diisocyanate, 2,4-toluene diisocyanate, 2,6-toluene diisocyanate, tetramethylxylene diisocyanate, p-xylylene diisocyanate, 1,4-phenylene diisocyanate, 4,4′-diphenylmethane diisocyanate, 2,4′-diphenylmethane diisocyanate, polymethylene polyphenyl polyisocyanates, 1,5-naphthylene diisocyanate, or urethane, allophanate, urea, biuret, carbodiimide, uretonimine or isocyanurate derivatives thereof, or combinations thereof.

20. A crosslinkable aqueous polyurethane dispersion according to claim 15, wherein said diacids are selected from the group consisting of succinic acid, glutaric acid, adipic acid, sebacic acid, hexahydrophtalic acid, isophtalic acid, phthalic anhydride or dimethyl terephthalate.

21. A crosslinkable aqueous polyurethane dispersion according to claim 15, wherein a proportion of the ketone group in said ketone polyester polyol in b) is in the range of 0.8 to 4 meq/g, preferably 1 to 3.5 meq/g, more preferably 2 to 3.5 meq/g.

22. A crosslinkable aqueous polyurethane dispersion according to claim 15, wherein said polymeric compounds in e) are polymeric polyols, MW 400-3000 Dalton.

23. A crosslinkable aqueous polyurethane dispersion according to claim 22, wherein said polymeric polyols are selected from the group consisting of polyether polyols, polycarbonate polyols, polyester polyols, polyesteramide polyols, dimer fatty polyols, polyolefin polyols or polysiloxane polyols.

24. A crosslinkable aqueous polyurethane dispersion according to claim 15, wherein said carboxylic acid polyol in c) is 2,2-bis(hydroxymethyl) propionic acid.

25. A crosslinkable aqueous polyurethane dispersion according to claim 15, wherein the tertiary amine in d) is selected from the group consisting of triethylamine, dimethylcyclohexylamine, N-methylmorpholine, N-ethylmorpholine, N,N-diisopropylethylamine, tris-(hydroxyethyl)amine, N,N-dimethylaminoethanol, or N,N-diethylaminoethanol.

26. A crosslinkable aqueous polyurethane dispersion according to claim 15, further comprising coalescing aids and/or additives.

27. A crosslinkable aqueous polyurethane dispersion according to claim 26, wherein said coalescing aids and/or additives are selected from the group consisting of waxes, matting agents, pigments, flow- and levelling agents and defoamers.

28. A crosslinkable aqueous polyurethane dispersion according to any claim 15, wherein said crosslinkable aqueous polyurethane dispersion is a floor coating composition.
